(19) United States
(12) Patent Application Publication
(10) Pub. No.: US 2021/0378452 A1
(43) Pub. Date: Dec. 9, 2021

(54) SHELLING APPARATUS FOR EGGS

(71) Applicant: Chase Johns, Springville, UT (US)

(72) Inventor: Chase Johns, Springville, UT (US)

(21) Appl. No.: 16/902,021

(22) Filed: Jun. 15, 2020

Related U.S. Application Data
(60) Provisional application No. 63/035,738, filed on Jun. 6, 2020.

(51) Int. Cl. A47J 43/14

(52) U.S. Cl. CPC A47J 43/14

(57) ABSTRACT

An egg shelling apparatus comprising two hingedly-connected working arms and a basket, wherein the working arms are compress together to crack a raw egg within the basket and force whites and yolk from the raw egg through apertures on a concave lower surface from the basket.

### BACKGROUND OF THE INVENTION

### Field of the Invention

This invention relates to a kitchen utensils and more particularly relates to a handheld implement adapted to cleanly remove shells from raw egg yolks.

### Description of the Related Art

Cracking and removing eggshells while cooking is time-consuming and problematic. The eggs do not crack cleanly, even when struck on the edges of pots and pans, leaving pieces of the shells in the raw yolks to be consumed. Feeding a group or even small family can require numerous eggs, sometimes with each member of the group eating multiple eggs. In addition to the primary problems relating to simple extraction of the eggshell from the yolks, mixing the yolk with exterior surfaces of the eggshells can be unsanitary, particularly in Europe and outside of the United States where egg are not required to undergo exterior washing and sanitization before sale. The use of hands or other repeatedly utensils to extract shells from cracked egg yolks can introduce further issues with contaminants of food products, and breaking cracked yolks to remove egg shells can cause additional aesthetic quality problems with the presentation of food products.

The problems with shelling eggs extend beyond the residential environment. Commercial cooks at diners and restaurants across the world are often obligated to crack and cook more than one hundred eggs during a shift.

There exist no means in the art of efficiently cracking or shelling raw eggs. Thus, it is desirable to provide a shelling implement which can be easily adapted and used to shell raw eggs.

### SUMMARY OF THE INVENTION

From the foregoing discussion, it should be apparent that a need exists for an egg shelling implement. Beneficially, such a system would overcome many of the difficulties of the prior art by providing a shelling implement which works efficiently. The present invention has been developed in response to the present state of the art, and in particular, in response to the problems and needs in the art that have not yet been fully solved by currently available apparati and methods. Accordingly, the present invention has been developed to provide an egg shelling implement comprising: an elongated, upper working arm hingedly affixed at median point to an elongated lower working arm, the upper working arm having: a distal portion extending laterally from the median point adapted to apply compressive force to an egg, and a proximal portion extending laterally from the median point away from the distal portion; the lower working arm affixed at the median point to the upper working arm, the lower working comprising a basket adapted to receive and partially envelope an egg, the lower working arm having: a distal portion extending laterally from the median point affixed to the basket, and a proximal portion extending laterally from the median point away from the distal portion; the basket affixed to the lower working arm comprises a concave lower surface defining a plurality of apertures between two millimeters and 25 millimeters through which whites and yolks of an egg may be forced; wherein the basket is adapted to receive the egg and facilitate crushing of the egg when the upper working arm is forced against the lower working arm.

The distal portions of each of the upper arm and the lower arm may be S-shaped. The lower working arm and basket may be formed as a single integrated piece.

The basket may be formed from a flexible polymeric material in some embodiments. The upper working arm and the lower working arm may be formed of one of: a rigid metal alloy and a rigid polymeric material.

In various embodiments, a plurality of apertures may have radius widths of between two millimeters and seven millimeters. The upper working arm may comprise a hinge portion defining a bore through which a bolt traverses.

In some embodiments, each of the upper working arm and the lower working arm may define a slot for receiving the hinge portion of a hingedly-connected working arm.

The basket may descend inferiorly from the lower working arm.

Each of the proximal portions may be substantially flat.

A top surface of the distal portion of the upper working arm may comprise a plurality of protuberances having superiorly rising flanges and defining a bore.

A top surface of the proximal portion of the lower working arm comprises a plurality of protuberances having superiorly rising flanges and defining a bore.

The distal portion of the upper working arm and the lower working may be forced together to apply compressive force to the egg and crack the egg within the basket and to force whites and yolk from the apertures defined by the lower concave surface of the basket.

A second egg shelling implement is provided comprising: an elongated, upper working arm hingedly affixed at median point to an elongated lower working arm, the upper working arm having: an S-shaped distal portion extending laterally from the median point adapted to apply compressive force to an egg, and a flat proximal portion extending laterally from the median point away from the distal portion; the lower working arm affixed at the median point to the upper working arm, the lower working comprising a basket adapted to receive and partially envelope an egg, the lower working arm having: an S-shaped distal portion extending laterally from the median point affixed to the basket, and a flat proximal portion extending laterally from the median point away from the distal portion; the basket affixed to the lower working arm comprises a concave lower surface defining a plurality of apertures through which whites and yolks of an egg may be forced; wherein the basket is adapted to receive the egg and facilitate crushing of the egg when the upper working arm is forced against the lower working arm.

The distal portion of the upper working arm and the lower working may be forced together to apply compressive force to the egg and crack the egg within the basket and to force whites and yolk from the apertures defined by the lower concave surface of the basket.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side perspective view of an egg shelling implement in accordance with the present invention;

FIG. 2 is a side perspective view of an egg shelling implement in accordance with the present invention;

FIG. 3 is a top perspective view of an egg shelling implement in accordance with the present invention;

FIG. 4 is a forward perspective view of an egg shelling implement in accordance with the present invention;

FIG. 5 is a rearward perspective view of an egg shelling implement in accordance with the present invention;

FIG. 6 is a lower perspective view of an egg shelling implement in accordance with the present invention;

FIG. 7 is a side perspective view of a working arm of an egg shelling implement in accordance with the present invention; and

FIG. 8 is a top perspective view of a working arm of an egg shelling implement in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

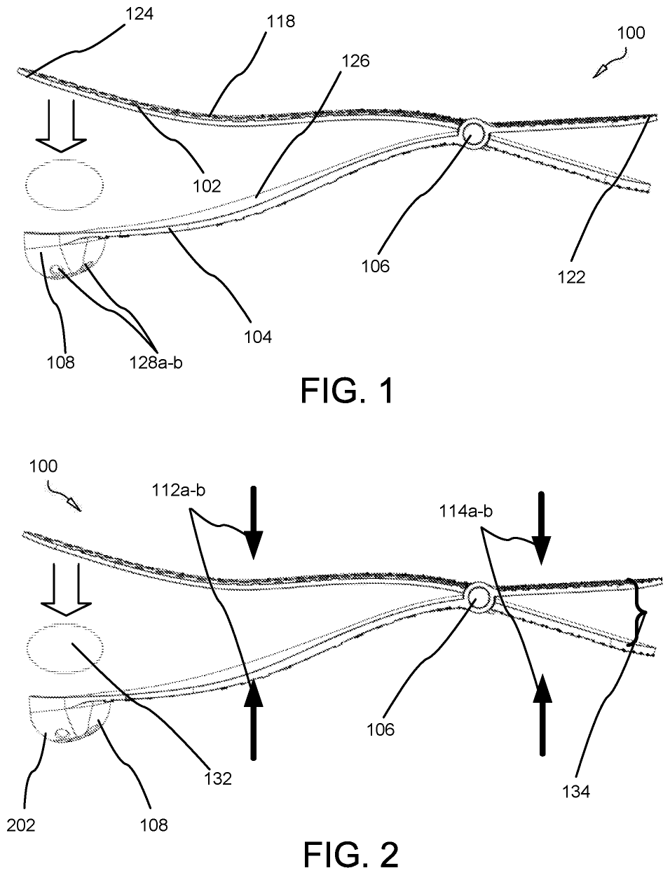

FIGS. 1 and 2 depict a side perspective view of an egg shelling implement 100 in accordance with the present invention.

The implement 100 comprises an elongated top working arm 102 and an elongated lower working arm 104. Both the top working arm 102 and the lower working arm 104 are S-shaped, wavy, or curved from a side perspective view.

The top working arm 102 and the lower working arm 104 are hingedly connected at a median point 106. The arms 102, 104 articulate about one another at the median point 106. The arms 102, 104 are hingedly affixed to one another in such a manner that the arms 102, 104 axially rotate about the median point 106 on a longitudinal plane intersecting the arms 102, 104 from a distal end 124 to a proximal end 122.

The proximal portion 122 (i.e., end) of the arms 102, 104 comprises the portions of the arms jutting laterally to the shown right of the median point 106. The proximal portion 122 of each arm 102, 104 is substantially planar across a top surface and bottom surface of the proximal portion 122.

The distal portion 124 (i.e., end) of the arms 102, 104 is wavy, with each distal portion of the arms 102, 104 adapted to contour one another when the implement/apparatus 100 in a closed position (i.e., when the distal portions of each arm 102, 104 are pushed into contact with one another). The implement 100 as shown is in a open configuration. The distal portion 124 and the proximal portion extend from the median point 106 in diametrically opposed directions.

The top surface 126 of the lower arm 104 is planar from forward side-to-side (and wavy, or S-shaped, from left to right). The top surface 118 of the top/upper arm 102 comprising a plurality of protuberances 604 (further described below).

The distal end 124 of the lower arm 104 comprises a basket 108, or cup 108, adapted to receive and partially envelop a raw egg 132. The basket 108 is concave as shown, and descends interiorly from the lower arm 104 such that the basket suspends the center of gravity of the egg 132 beneath the top surface 126 of the lower arm 104.

The proximal portions 122 are substantially flat from a side perspective view instead of wavy or S-shaped.

The basket 108 defines a plurality of apertures 128 on its lower concave surface 202. The basket 108 may be dimensioned to receive mesolecithal and/or macrolecithal eggs, or eggs of a specific size of species, such as eggs by way of example from a chicken, quail, goose or ostrich. In typical embodiments, the egg 132 is prolate spheroid in shape.

In various embodiments, the basket 108 is formed as a single integrated piece with the lower working arm 104. Alternatively, the basket 108 may be formed of flexible, polymeric components, such as nylon straps.

The apertures 128 are dimensioned to have radi of sufficient width to allow through passage of the white and yolks of the egg 132, but not the shell of the egg 132.

The arms 102, 104 are closed once the egg 132 is received into the basket 108. The compressive forces between the arms 102, 104 crush the egg 132 within the basket 108 and these compressive forces then force the white (i.e., glair) and yolk interiorly from the basket 108 such that white and yolk are deposited onto a dish or container positioned beneath the implement 100.

Because the white and yolk of the egg 132 are viscous, but fluid, the white and yolk of the egg 132 can be forced from the basket 108 through compression while the shell of the egg 132 remains behind.

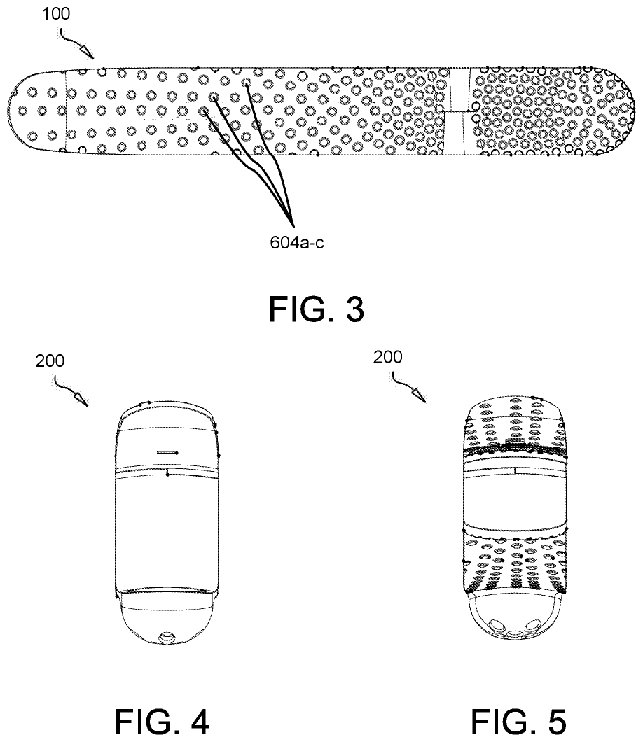

FIG. 3 is a top perspective view of an egg shelling implement 600 in accordance with the present invention.

A plurality of protuberances 604 space across the top surface 118 (approximately across the x and z axes) of the implement 100. The protuberances 604 comprise annular flanges protuberating from the top surface 118 and comprises bores, or recesses, within the flanges. These protuberances 604 are adapted to help form friction fits with an operator's hands and to relieve pressure from an egg 132 beneath the protuberances 604. The protuberances 604 may be spaced at even intervals across the top surface 118 or may be staggered, or otherwise patterned in their placement across the top surface 118.

The lower working arm 104 and the upper working arm 102 may be fabricated of rigid polymeric components, such as fiberglass. Additionally or alternatively, the upper and lower working arms 102, 104 may be fabricated of a metal or metal alloy, such as steel, aluminum, brass or titanium. Alternatively, the upper and lower arms 102, 104 may fabricated of organic materials, such as wood, resin or leather.

FIG. 4 is a forward perspective view of an egg shelling implement in accordance with the present invention.

As shown.

FIG. 5 is a rearward perspective view of an egg shelling implement in accordance with the present invention.

As shown.

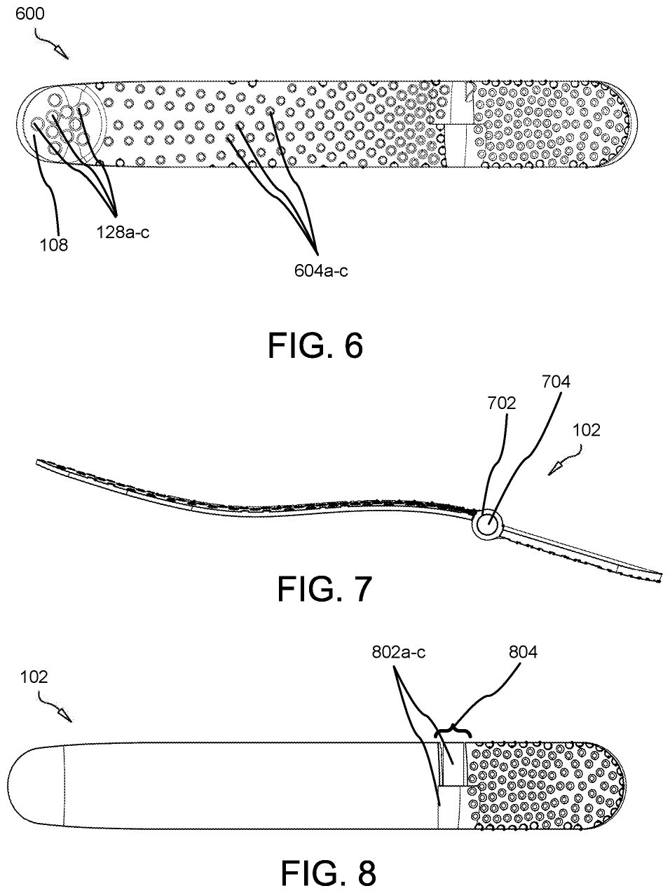

FIG. 6 is a lower perspective view of an egg shelling implement 100 in accordance with the present invention.

The lower concave surface of the basket 108 comprises nine apertures 128 in the shown embodiment. These apertures 128 may vary in radius width from two millimeters to 25 millimeters. Although all of the apertures 128 in the shown embodiment are of equal size, in various other embodiments the apertures 128 may vary in size, such that there are smaller apertures 128a between two millimeters and five millimeters in radius and larger apertures 128b greater than five millimeters in width.

The lower arm 104 also comprises protuberances 604 as shown. The bores in these protuberances are smaller in radius width than the radius width of the apertures 128 of the basket 108.

FIG. 7 is a side perspective view of a working arm 102 of an egg shelling implement in accordance with the present invention.

The working arm 102 comprises a hinge portion 702 defining a hollow bore 704 traversing the arm 102. In various embodiments, a screw, bolt, or even cantilevering protuberance from the arm 104 in inserted into the bore 704 to hingedly affix the arm 102 to the arm 104.

FIG. 8 is a top perspective view of a working arm 102 of an egg shelling implement in accordance with the present invention.

The arm 102 defines a slot 804, or recess, which receives the hinge portion 702 of a hingedly-affixed arm 104. The proximal portion 122 of the arm 102 comprises protuberances 604 on the top surface while the top surface 118 of the distal portion 124 is smooth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An egg shelling implement comprising:
an elongated, upper working arm hingedly affixed at median point to an elongated lower working arm, the upper working arm having:
a distal portion extending laterally from the median point adapted to apply compressive force to an egg, and
a proximal portion extending laterally from the median point away from the distal portion;
the lower working arm affixed at the median point to the upper working arm, the lower working comprising a basket adapted to receive and partially envelope an egg, the lower working arm having:
a distal portion extending laterally from the median point affixed to the basket, and
a proximal portion extending laterally from the median point away from the distal portion;
the basket affixed to the lower working arm comprises a concave lower surface defining a plurality of apertures between two millimeters and 25 millimeters through which whites and yolks of an egg may be forced;
wherein the basket is adapted to receive the egg and facilitate crushing of the egg when the upper working arm is forced against the lower working arm.

2. The apparatus of claim 1, wherein the distal portions of each of the upper arm and the lower arm are S-shaped.

3. The apparatus of claim 1, wherein the lower working arm and basket are formed as a single integrated piece.

4. The apparatus of claim 1, wherein the basket is formed from a flexible polymeric material.

5. The apparatus of claim 1, wherein the upper working arm and the lower working arm are formed of one of: a rigid metal alloy and a rigid polymeric material.

6. The apparatus of claim 1, wherein the a plurality of apertures are between two millimeters and seven millimeters in radius width.

7. The apparatus of claim 1, wherein upper working arm comprises a hinge portion defining a bore through which a bolt traverses.

8. The apparatus of claim 7, wherein each of the upper working arm and the lower working arm define a slot for receiving the hinge portion of a hingedly-connected working arm.

9. The apparatus of claim 1, wherein the basket descends inferiorly from the lower working arm.

10. The apparatus of claim 1, wherein each of the proximal portions are substantially flat.

11. The apparatus of claim 1, wherein a top surface of the distal portion of the upper working arm comprises a plurality of protuberances having superiorly rising flanges and defining a bore.

12. The apparatus of claim 1, wherein a top surface of the proximal portion of the lower working arm comprises a plurality of protuberances having superiorly rising flanges and defining a bore.

13. The apparatus of claim 1, wherein the distal portions of the upper working arm and the lower working are forced together to apply compressive force to the egg and crack the egg within the basket and to force whites and yolk from the apertures defined by the lower concave surface of the basket.

14. An egg shelling implement comprising:
an elongated, upper working arm hingedly affixed at median point to an elongated lower working arm, the upper working arm having:
an S-shaped distal portion extending laterally from the median point adapted to apply compressive force to an egg, and
a flat proximal portion extending laterally from the median point away from the distal portion;
the lower working arm affixed at the median point to the upper working arm, the lower working comprising a basket adapted to receive and partially envelope an egg, the lower working arm having:
an S-shaped distal portion extending laterally from the median point affixed to the basket, and
a flat proximal portion extending laterally from the median point away from the distal portion;
the basket affixed to the lower working arm comprises a concave lower surface defining a plurality of apertures through which whites and yolks of an egg may be forced;
wherein the basket is adapted to receive the egg and facilitate crushing of the egg when the upper working arm is forced against the lower working arm.

15. The apparatus of claim 14, wherein the distal portions of the upper working arm and the lower working are forced together to apply compressive force to the egg and crack the egg within the basket and to force whites and yolk from the apertures defined by the lower concave surface of the basket.
